(19) United States
(12) Patent Application Publication
(10) Pub. No.: US 2017/0083941 A1
(43) Pub. Date: Mar. 23, 2017

(54) Media Planning Tool

(71) Applicant: Facebook, Inc., Menlo Park, CA (US)

(72) Inventors: Surupa Biswas, Bellevue, WA (US); Xin Liu, Palo Alto, CA (US); Aleksey Sergeyevich Fadeev, Seattle, WA (US)

(21) Appl. No.: 14/860,995

(22) Filed: Sep. 22, 2015

(51) Int. Cl. G06Q 30/02

(52) U.S. Cl. CPC G06Q 30/0255; G06Q 30/0275

(57) ABSTRACT

An advertising system stores records of web publishers accessed by each of a plurality of users of the online system, where the records indicate for each of the web publishers which of the users have accessed sites of the web publisher. A set of users targeted by an advertiser for receiving one or more advertisements from the advertiser is received. Using the stored records, one or more web publishers are selected to recommend to the advertiser for publishing the one or more advertisements targeted to the set of users. The web publishers are selected using a likelihood of the target users accessing content provided by the selected publishers based on the target users having previously accessed sites of the web publishers. The one or more selected web publishers are recommended to the advertiser for bidding to present ads to the target users.

### BACKGROUND

This disclosure relates to identifying websites on which to publish advertisements to reach target users.

Advertisers often display web advertisements to users via a number of different websites. The advertisers may target particular advertisements to particular users, based for example on demographics of the users, products or services previously purchased by the users, products viewed by the users, or advertisements with which the users previously interacted. For example, as users navigate between websites and perform actions on the websites such as viewing and purchasing products, the advertisers receive information about the users' actions. This information is then used to identify users to whom the advertisers target future advertisements.

When targeting advertisements to a particular user, advertisers may bid on ad space on one or more ad publishers by providing the publisher with ad content to display to the user and an identifier of the user or characteristic of the user. When the user accesses the publisher's web page, the publisher provides ad content to the user based on bids from the advertisers. However, it is difficult for advertisers to determine which publishers' websites the targeted users are likely to visit. Advertisers therefore may bid on ad space on publishers the targeted users do not visit or visit infrequently, thus reducing the probability of the target users seeing the advertisers' ads.

### SUMMARY

An advertising system recommends web publishers to an advertiser for presenting advertisements to target users selected by the advertiser. To generate the recommendations, the advertising system aggregates information about web publishers visited by each of a plurality of users of the system and stores records of the web publishers the users have accessed. In one embodiment, the advertising system tracks advertisement impressions (“ad impressions”) and links the ad impressions to identities of users viewing the ads and web publishers displaying the ads to users, generating a record for each ad impression that identifies the user who viewed the ad and the web publisher that displayed the ad to the user.

The advertising system receives identifiers of a set of target users targeted by the advertiser for receiving one or more advertisements from the advertiser. Using the stored records, the advertising system selects one or more web publishers to recommend to the advertiser. The web publishers are selected based on a likelihood of the target users accessing content provided by the selected publishers. For example, the advertising system selects web publishers the target users accessed a greatest number of times during a specified interval of time, or selects web publishers the target users accessed at least a threshold number of times. The selected web publishers are recommended to the advertiser, which may then bid to display advertisements to the target users via the recommended web publishers. By recommending publishers to the advertiser, the advertising system enables the advertiser to bid on ad space that is likely to be accessed by the target users, thereby improving the likelihood of the target users viewing the advertiser's ads.

### BRIEF DESCRIPTION OF THE DRAWINGS

FIG. 1 is a block diagram of a system environment in which an advertising system operates, according to one embodiment.

FIG. 2 illustrates an example IP cluster interacting with an advertising system and online system, according to one embodiment.

FIG. 3 illustrates example communications between a user and an advertising system or online system, according to one embodiment.

FIG. 4A is a block diagram of an architecture of an online system, according to one embodiment.

FIG. 4B is a block diagram of an architecture of an advertising system, according to one embodiment.

FIG. 5 is an interaction diagram illustrating a process for logging impressions and conversions of an advertisement by an advertising system, according to one embodiment.

FIG. 6 is a flowchart illustrating a process for recommending one or more publishers to an advertiser for displaying ad content to users, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

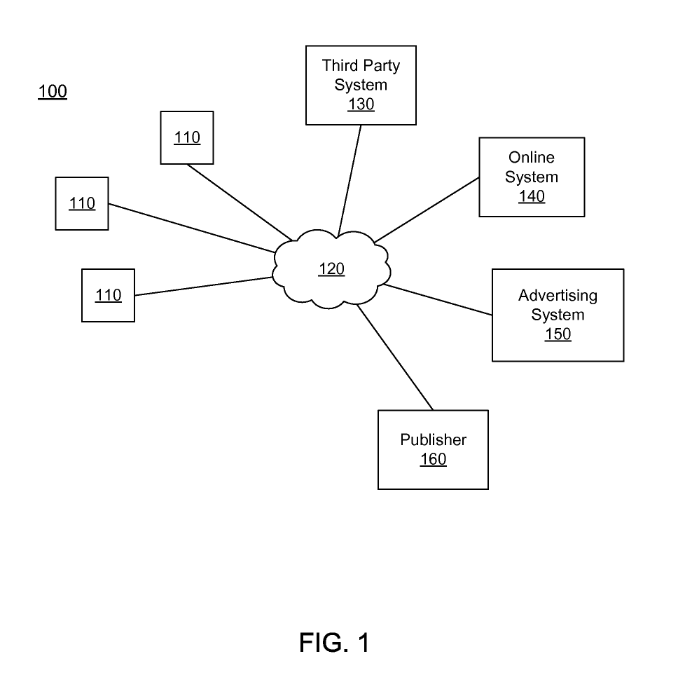

FIG. 1 is a high level block diagram of a system environment 100 for an advertising (ad) system 150. The system environment 100 shown by FIG. 1 comprises one or more client devices 110, a network 120, one or more third party systems 130, an online system 140, one or more publishers 160, and the advertising system 150. In alternative configurations, different and/or additional components may be included in the system environment 100. The embodiments described herein can be adapted to online systems that are not online systems or advertising systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™. In a third embodiment, a client device 110 executes an online system application that interacts with the online system 140 thereby allowing the user of the client device 110 to perform various tasks supported by the online system 140. In other examples, the client devices 110 may provide content received from third party systems 130 or the advertising system 150 to the users of the client devices 110.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 are coupled to the network 120 for communicating with the online system 140, the advertising system 150, and the publishers 160. A third party website 130 may communicate information to the online system 140 and advertising system 150, such as advertisements or content provided by the third party website 130. Similarly, the third party system 130 communicates information to the advertising system 150 regarding advertisements or content provided by the third party system 130 including cookies or other objects generated by a client device 110.

Advertisers (parties associated with third party systems 130) and other entities with an online presence (including the online system 140) create ad content to be provided for display within ad spaces on web pages and within mobile applications. An advertiser in one example may provide a publisher 160 with an advertisement to present to users of the publisher 160. Advertisers purchase ad space in order to help drive user traffic to their own web pages and servers. For example, provided ad instances may include computer code that redirects the client device 110 to load content from the advertiser's web server responsive to receiving an interaction (e.g., a touch input) that corresponds to the provided ad instance. This may be simply a web address, or a more sophisticated algorithm. Advertisers use their web pages to promote and/or sell goods or services to users. In some instances, if an external web page contains ad content, the provided web page will include computer code indicating where the advertiser's ad content can be obtained.

The publishers 160 communicate with the third party systems 130 to display advertisements provided by the third party systems 130 to users of the publishers 160. In one embodiment, a publisher 160 provides content or other information for presentation via a client device 110, for example by one or more web pages. In another embodiment, a publisher 160 is an application provider communicating information describing applications for execution by a client device 110 or communicating data to client devices 110 for use by an application executing on the client device 110. The publishers 160 provide space to display ads to users accessing content of the publishers. For example, the publishers 160 allot space on a webpage to display ads adjacent to the publisher's content. The publishers 160 receive bids from advertisers associated with third party systems 130 display the advertisers' ads, and selects ads to fill available space based on the received bids.

The advertising system 150 helps advertisers target users to whom to display their advertisements and the advertiser will often work with the advertising system 150 to determine an ad campaign strategy suitable for the advertiser. In one embodiment, the advertising system 150 is a collection of one or more ad servers and other components and entities. The advertising system 150 logs web traffic to web pages and mobile software applications associated with various advertisers, and stores the logged web traffic. The logged web traffic provides the advertising system 150 with information regarding the activities, interests, habits, and purchasing decisions of users of client devices 110. The advertising system 150 processes this information to assist advertisers. In one embodiment, the advertising system 150 logs the public IP (Internet Protocol) address of client devices 110 accessing various web pages, such as pages associated with a variety of advertisers or other online systems such as the online system 140 receiving assistance from the advertising system 150. In one example, as a user browses a web page and interacts with an advertisement via a web browser installed on the user's client device 110, the browser, responsive to the user interacting with an advertisement on the client device 110, communicates the user's IP address, one or more cookies associated with the client device 110, the information included in the one or more cookies associated with the client device 110, the time at which the user interacted with the advertisement, and any other relevant information to the advertising system 150.

Based on the logged web traffic, the advertising system 150 determines which publishers 160 the users of the client devices 110 are likely to visit. Using the publishers visited by one or more users during a previous time period, the advertising system 150 determines a likelihood of the one or more users accessing the publishers during a future time period. The advertising system 150 recommends an advertiser bid to present ads to the users via one or more of the web publishers the users are likely to visit in the future, thus increasing a likelihood of the users viewing the advertiser's ads. In one embodiment, the advertising system 150 provides the advertisers (e.g., the third party systems 130) with a media tool by which the advertisers can view the performance of their ad campaigns, upload lists of users the advertisers intend to target in a future ad campaign, and view the recommendations from the advertising system 150 for publishers to display the ads to the target users.

Apart from receiving information from the client devices 110, the advertising system 150 may also communicate with the online system 140. The advertising system 150 may provide ad content to the online system 140 for display to users of the online system 140. Furthermore, the advertising system 150 may leverage information associated with a user stored by the online system 140 to identify clusters of client devices 110 associated with an IP address for example. Alternatively, the advertising system 150 may leverage the user information collected by the online system 140 to create associations between cookies logged by the advertising system 150 and users of the online system 140.

One example of an online system 140 is a social networking system. The online system 140 maintains information about users of the online system 140 including information identifying the user, tastes and preferences of the user and other users of the online system 140 to which the user is connected. The online system 140 presents content items to a user of the online system 140 via a news feed for example. Content items presented include sponsored content items such as advertisements as well as non-sponsored content items such as images or text generated by users of the online system 140. The online system 140 maintains for each user an identifier such as a user ID identifying the user, thereby allowing the online system 140 to monitor actions of the user on the online system 140. The online system 140 may also collect additional information associated with a user such as an identifier identifying a client device 110 associated with the user, an IP address associated with a user's client device 110, likes and preferences of users of the online system 140 or connections between users of the online system 140.

Both the advertising system 150 and the online system 140 monitor web activity of the user and maintain information associated with the user. The online system 140 in particular includes information provided by the user or inferred by the online system 140 that identifies the user, such as the name of the user or the user's contact information. The advertising system 150 however, does not necessarily maintain information associated with the identity of the user but may monitor activity of a user on a client device 110 via one or more cookies for example. In one embodiment, the advertising system 150 may leverage the identification information stored by the online system 140 to associate a cookie or identifier stored by the advertising system 150 with a particular individual or user of the online system 140. Thus, by communicating with the online system 140 the advertising system 140 may more accurately be able to identify the user or individual associated with an identifier maintained and stored by the advertising system 150. In some embodiments, the online system 140 and the advertising system 150 are the same entity or the functionalities are combined into one entity. For example, the online system might be a social networking system that also acts as an advertising system that helps advertisers target users to whom to display their advertisements.

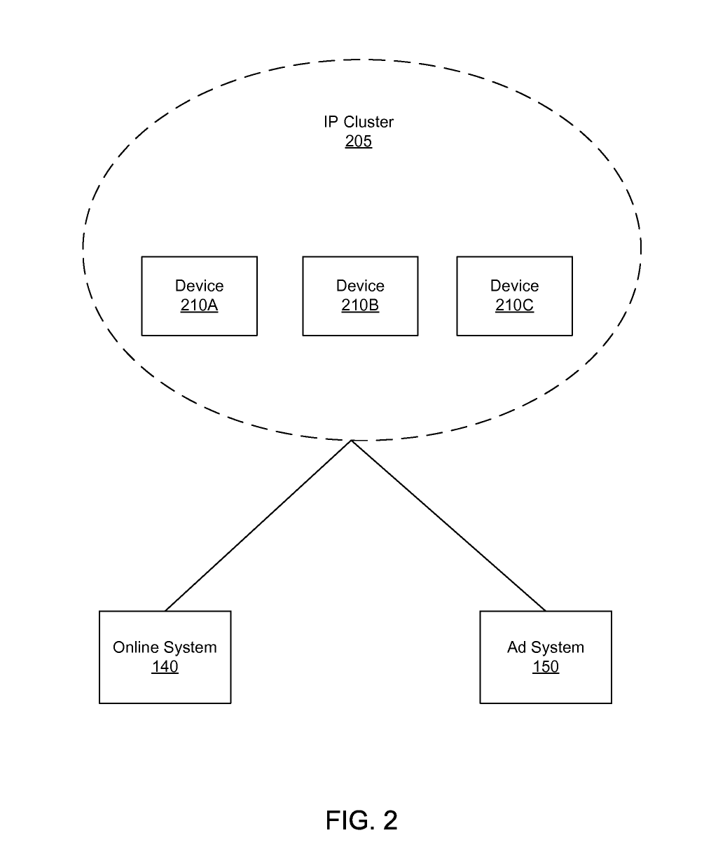

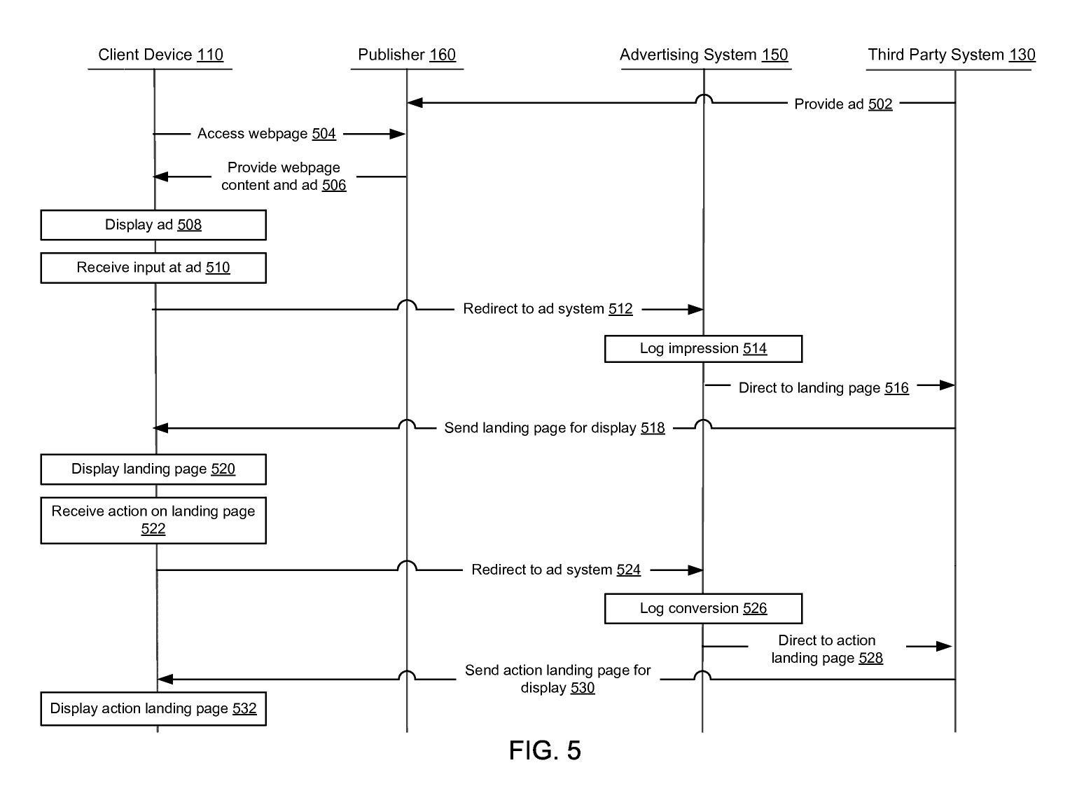

FIG. 2 is an example of an IP cluster interacting with the advertising system 150 and the online system 140, according to one embodiment. An IP (Internet Protocol) cluster 205 is a group of client devices 110 as shown in FIG. 1, or applications such as browsers executing on a client device 110, that share the same public IP address during a given time span. In the example of FIG. 2, the client devices are referred to as device 210A, device 210B, and device 210C (collectively referenced as device 210), are included in the IP cluster 205. Thus, devices 210A, 210B, and 210C all share the same public IP address for a given time span and form an IP cluster 205. An IP cluster 205 may be uniquely identified based on the public IP address associated with various devices 210 and usage times associated with various devices 210. For example, devices 210 having a similar public IP address and overlapping usage time periods are identified as an IP cluster 205, as is further described in conjunction with FIG. 5 below.

Devices 210 in an IP cluster 205 may communicate various kinds of information with the online system 140 as well as the advertising system 150. For example, a device 210 in an IP cluster 205 may communicate the public IP address of the device 210 as well as the user ID of the user accessing or interacting with the online system 140 via an application executing on the device 210. Further, the device 210 may also communicate usage time information associated with the user using the device 210, such as the time at which the user first accessed the online system 140 during a session, or the time at which a user last interacted with the online system 140 via the device 210. Alternatively, the online system 140 may monitor the various actions performed by a user to determine the time at which different actions are performed by the user during a given interaction session. In one example, the devices 210 send communications to the online system 140 responsive to receiving interactions associated with content provided by the online system 140. The communications may include the user id associated with the user of the device 210, a client device 110 identifier identifying the device 210 used by the user, the IP address used by the client device 110 to communicate with the online system 140, information associated with the interaction performed by the user, the time at which the user performed the interaction, and any additional information such as a geo-location value identifying the location of the device 210 when the user performed the user interaction. In some cases, the online system 140 determines certain of this information rather than receiving it from the device 210. For example, the system 140 may determine and log the time and date associated with the action.

Similarly the IP cluster 205 also communicates with the advertising system 150. A device 210 in an IP cluster 205 may transmit a variety of information to the advertising system 150. For example, the device 210 in the IP cluster 205 transmits the IP address of the device 210 and the IP cluster 205, the time at which the user began a browsing session on the IP address, or one or more cookies on the device 210. The device 210 may communicate information with the advertising system 150 responsive to receiving a user interaction with content received from a third party system 130, the advertising system 150 or the online system 140, such as responsive to the user viewing content during a browsing session. In one example, a device 210 in the IP cluster 205 sends information associated with one or more cookies to the advertising system 150, including the cookie ids identifying the one or more cookies, the time at which the user interacted with content, and additional information such as a geo-location value identifying the location of the device 210 when the user interacted with the content. In some cases, the advertising system 150 determines certain portions of this information rather than receiving it from the device 210, such as the time and date associated with the action. In other examples, the a device 210 in the IP cluster 205 sends device attributes, such as screen size of the device 210, memory of the device 210, the CPU of the device 210, or a device identifier.

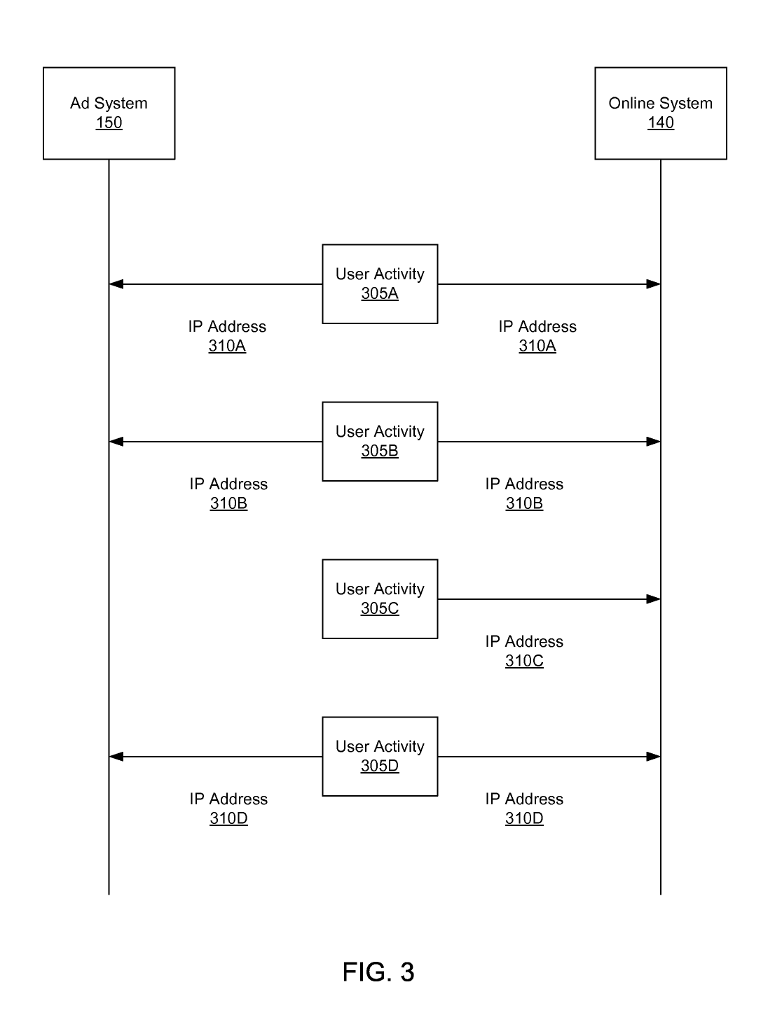

FIG. 3 is an example diagram illustrating communications between the user and the advertising system or the online system over different periods of time, according to one embodiment. The user via one or more applications executing on the client device 110 may communicate with the online system 140 and the advertising system 150 over different periods of time, such as during the course of a day. The communications to the online system 140 and the advertising system 150 may overlap during certain portions of a period of time. For example, the user communicates with the online system 140 during the time periods of 10 AM-12 PM and 2 PM-4 PM of a particular day, and with the advertising system 150 during the time periods of LOAM-12 PM during the same day. In one embodiment, the public IP address of the client device 110 is included in the communications between the client device 110 and the online system 140 and the communications between the client device 110 and the advertising system 150.

In the example of FIG. 3, the user performs a sequence of interactions on the client device 110 resulting in a sequence of IP address communications being communicated to the online system 140 and the advertising system 150 during different periods of time. The user performs one or more user activities 305A resulting in the communication of an IP address 310A during a first period of time to both the advertising system 150 and the online system 140. The user may then perform a different set of user activities during a second period of time resulting in the communication of IP address 310B to both the advertising system 150 and the online system 140. The IP address 310B may be different from the IP address 310A. During a third period of time the user may interact with the client device 110 performing user activities 305C resulting in the communication of IP address 310C to the online system 140 alone and not the advertising system 150. For example, the user may in the third period of time only interact with content provided by the online system 140.

During a fourth period of time the user may perform a user activity 305D resulting in the communication of IP address 310D to both the online system 140 and the advertising system 150. Thus, as shown in the example of FIG. 3 the user may interact with a variety of content presented to the user via the client device 110. As the user interacts with the different content, the IP address 310 associated with the user at the time of the interaction is communicated to either the online system 140 or the advertising system 150 or to both, depending, for example, on the content with which the user interacted. Therefore, there exist overlapping periods of time within which the IP address of the user during the period of time is communicated to both the online system 140 and the advertising system 150. In addition to communicating the IP address 310 associated with the user, the client device 110 may also communicate unique cookies associated with the user, the user id associated with the user on the online system 140 and time information identifying the time at which the IP address was communicated by the client device 110. In some cases, the online system 140 or advertising system 150 determines portions of this information rather than receiving it from the client device 110.

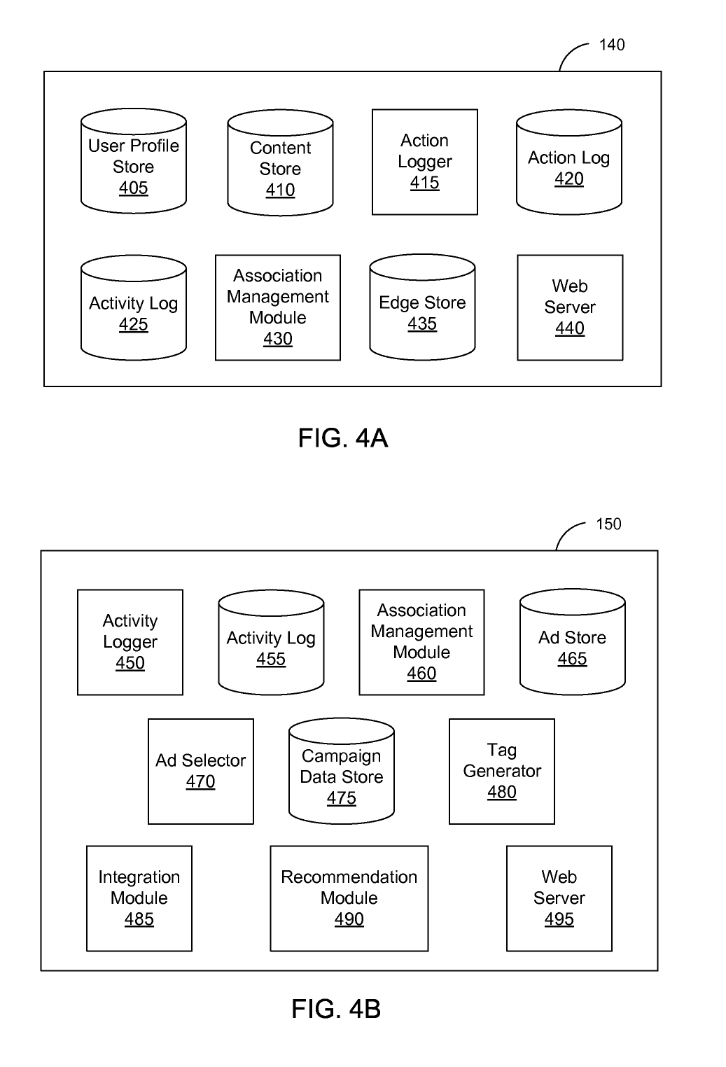

FIG. 4A is an example block diagram of an architecture of the online system. The online system 140 shown in FIG. 4A includes a user profile store 405, a content store 410, an action logger 415, an action log 420, an activity log 425, an association management module 430, a communication module 435, an edge store 440, and a web server 445. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 405. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 140 displayed in an image. A user profile in the user profile store 405 may also maintain references to actions by the corresponding user performed on content items in the content store 410 and stored in the action log 420. Further, a user profile in the user profile store 405 includes a user id identifying the user associated with the user profile.

While user profiles in the user profile store 405 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 410 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 410, such as status updates, photos tagged by users to be associated with other objects in the online system, events, groups or applications. In some embodiments, objects are received from third-party applications or third-party applications separate from the online system 140. In one embodiment, objects in the content store 410 represent single pieces of content, or content “items.” Hence, users of the online system 140 are encouraged to communicate with each other by posting text and content items of various types of media through various communication channels. This increases the amount of interaction of users with each other and increases the frequency with which users interact within the online system 140. In one embodiment, the content store 410 includes both sponsored content items, such as advertisements, as well as non-sponsored content items, such as images generated by a user of the online system 140.

The action logger 415 receives communications about user actions internal to and/or external to the online system 140, populating the action log 420 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 420.

The action log 420 may be used by the online system 140 to track user actions on the online system 140, as well as actions on third party systems 130 that communicate information to the online system 140. Users may interact with various objects on the online system 140, and information describing these interactions are stored in the action log 410. Examples of interactions with objects include: commenting on posts, sharing links, and checking-in to physical locations via a mobile device, accessing content items, and any other interactions. Additional examples of interactions with objects on the online system 140 that are included in the action log 420 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 420 may record a user's interactions with advertisements on the online system 140 as well as with other applications operating on the online system 140. In some embodiments, data from the action log 420 is used to infer interests or preferences of a user, augmenting the interests included in the user's user profile and allowing a more complete understanding of user preferences.

The action log 420 may also store user actions taken on a third party system 130, such as an external website, and communicated to the online system 140. For example, an e-commerce website that primarily sells sporting equipment at bargain prices may recognize a user of a online system 140 through a social plug-in enabling the e-commerce website to identify the user of the online system 140. Because users of the online system 140 are uniquely identifiable, e-commerce websites, such as this sporting equipment retailer, may communicate information about a user's actions outside of the online system 140 to the online system 140 for association with the user. Hence, the action log 420 may record information about actions users perform on a third party system 130, including webpage viewing histories, advertisements that were engaged, purchases made, and other patterns from shopping and buying.

In one embodiment, the action logger 415 receives communications including an IP address associated with the client device 110 of the user, a user id associated with the user of the client device 110 and the time at which the communication was sent by the client device 110 or received by the online system 140, and populates the activity log 425 with the information included in the received communications. In some examples, the action logger 415 may also include action information stored in the action log 420 in the activity log 425 and associate the action information with the various communications and user information stored in the activity log 425. Thus, the activity log 425 includes information describing the various communications received by the online system 140 from various client devices 110 communicating with the online system 140.

An association management module 430 creates and manages associations between different entities, objects, users, and information of the online system 140. In one embodiment, the association management module 430 identifies, from information included in the activity log 425, an association between a user of the online system 140 and an IP address. In another example, the association management module 430 identifies, from the information included in the activity log 425, an association between a user of the online system 140 and an IP cluster including a plurality of devices. The association management module 430 may store the associations in the activity log 425 or the user profile store 405.

In one embodiment, when the advertising system 150 receives a cookie not synced to a user identifier (an “unsynced cookie”), the association management module 430 may communicate with the advertising system 150 to identify an association between the unsynced cookie and a user of the online system 140. The association management module 430 may identify an association between an unsynced cookie and a user of the online system 140 based on an IP address associated with the various communications received by the online system 140 including information about the user, such as the user ID of the user, and communications received by the advertising system 150 including information about the unsynced cookie, such as the unsynced cookie id identifying the unsynced cookie. By identifying an association between an unsynced cookie provided by the advertising system 150 and a user of the online system 140, the association management module 430 is able to further identify information associated with the user, such as the client device 110 associated with the unsynced cookie or the information stored by the advertising system 150 that is associated with the unsynced cookie. The association management module 430 may store the association between an unsynced cookie and the user of the online system in the activity log 425 or the user profile store 405.

In one embodiment, an edge store 435 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system, sharing a link with other users of the online system, and commenting on posts made by other users of the online system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 435 also stores information about edges, such as affinity scores for objects, interests, and other users. Affinity scores, or “affinities,” may be computed by the online system 140 over time to approximate a user's affinity for an object, interest, and other users in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 435, in one embodiment. Alternatively, each interaction between a user and a specific object is stored as a separate edge. In some embodiments, connections between users may be stored in the user profile store 405, or the user profile store 405 may access the edge store 435 to determine connections between users.

The web server 440 links the online system 140 via the network 120 to the one or more client devices 110, as well as to the one or more third party systems 130, and the advertising system 150. The web server 140 serves web pages, as well as other web-related content, such as JAVA®, FLASH®, XML and so forth. The web server 440 may receive and route messages between the online system 140 and the client device 110, for example, instant messages, queued messages (e.g., email), text messages, short message service (SMS) messages, or messages sent using any other suitable messaging technique. A user may send a request to the web server 440 to upload information (e.g., images or videos) that are stored in the content store 410. Additionally, the web server 440 may provide application programming interface (API) functionality to send data directly to native client device operating systems, such as IOS®, ANDROID™, WEBOS® or RIM®.

FIG. 4B is an example block diagram of an architecture of the advertising system 150. The advertising system 150 shown in FIG. 4B includes an activity logger 450, an activity log 455, an association management module 460, an ad store 465, an ad selection 470, a campaign data store 475, a tag generator 480, an integration module 485, a recommendation module 490, and a web server 495. In other embodiments, the advertising system 150 may include additional, fewer, or different components for various applications. Conventional components such as network interfaces, security functions, load balancers, failover servers, management and network operations consoles, and the like are not shown so as to not obscure the details of the system architecture.

The activity logger 450 receives communications about user activity on websites of the publishers 160 and the online system 140. Examples of user activity include viewing a web page hosted by a publishers 160, interacting with content provided by the online system 140 or a publisher 160, interacting with one or more advertisements, purchasing different items or products, and clicking or interacting with various interfaces provided by a publisher 160 or an advertiser associated with a third party system 130.

In one embodiment, the activity logger 450 receives communications including an IP address associated with the client device 110, one or more cookies stored on the client device 110, a cookie ID identifying the one or more cookies, action information describing an activity or action performed by a user, and time information describing the time at which the communication was sent from the client device 110. The activity logger 450 populates the activity log 455 with the information included in the received communications. Thus, the activity log 455 includes information describing the various communications received by the advertising system 150 from various client devices 110 communicating with the advertising system 150.

An association management module 460 creates and manages associations between different cookies and information stored by the advertising system 150. In one embodiment, the association management module 460 may communicate with the online system 140 to identify an association between an unsynced cookie received by the advertising system 150 and a user of the online system 140. The association management module 460 may identify an association between an unsynced cookie and a user of the online system 140 based on an IP address associated with the various communications received by the online system 140 including information about the user, such as the user id of the user, and communications received by the advertising system 150 including information about the unsynced cookie, such as the unsynced cookie ID identifying the unsynced cookie. By identifying an association between an unsynced cookie received by the advertising system 150 and a user of the online system 140 the association management module 460 is able to further identify information associated with the unsynced cookie, such as the client device 110 associated with the user of the online system 140 or the information stored by the online system 140 that is associated with the user such as preferences of the user or connections of the user. The association management module 460 may store the association between an unsynced cookie and the user of the online system in the activity log 455.

In one embodiment, the association management module 460 identifies an association between two cookies stored in the activity log 455. The association management module 460 may identify an association between two cookies based on an IP address associated with the two cookies and the time at which communications including the two cookies are received from the client device using the IP address. The association management module 460 stores the association identified between two cookies in the activity log.

In one embodiment, one or more advertisement requests (“ad requests”) are included in the ad store 465. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The advertisement content may also be part of an ad campaign, in which one or more pieces of advertisement content share a budget, timeframe, and/or performance objective. Examples of performance objectives include impressions and conversions. Impressions occur when a user is provided with an advertisement or when a user that is viewing an advertisement clicks on the advertisement. Conversions occur when the user viewing the advertisement completes the action that the advertisement is promoting. For example, if the advertisement is promoting sale of a pair of COLE HAAN® shoes, the user buying the pair of shoes would be a conversion.

The bid amount is associated with an advertisement by an advertiser and is used to determine an expected value, such as monetary compensation, provided by an advertiser to the advertising system 150 if the advertisement is presented to a user, if the advertisement receives a user interaction, or based on any other suitable condition. For example, the bid amount specifies a monetary amount that the advertising system 150 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with content in the advertisement request. For example, targeting criteria are a filter to apply to fields of a user profile, edges, and/or actions associated with a user to identify users having user profile information, edges or actions satisfying at least one of the targeting criteria. Hence, the targeting criteria allow an advertiser to identify groups of users matching specific targeting criteria, simplifying subsequent distribution of content to groups of users.

In one embodiment, the targeting criteria may specify actions or types of connections between a user and another user or object of the advertising system 150. The targeting criteria may also specify interactions between a user and objects performed external to the advertising system 150, such as on the online system 140 or a publisher 160. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in the targeting criteria allows advertisers to further refine users eligible to be presented with content from an advertisement request. As another example, targeting criteria may identify users having a connection to another user or object or having a particular type of connection to another user or object.

In some cases, the advertising system 150 may itself provide and possibly even serve ads to users, while in other cases the third party system 130 directly serves ads to the publishers 160. Where the advertising system 150 serves ads, when an opportunity to present an advertisement is received for a user, e.g., from an ad request, the ad selector 470 selects one or more advertisements from the ad store 465 for presentation to the user. In one embodiment, the ad selector 470 identifies targeting criteria associated with a user and retrieves ad requests having the targeting criteria. The ad selector 470 may retrieve additional user characteristics from the user profile store 305, the content store 310, the action log 320, and the edge store 325 and account for the additional user characteristics when evaluating ad requests. Based on characteristics of the user (“user characteristics”) the ad selector 470 determines a user's likelihood of interacting with the content of various ad requests. In one embodiment, the ad selector 470 uses an auction process to rank ad requests according to expected values to the advertising system 150 for presenting content from various ad requests, with an expected value of an ad request based on a bid amount associated with the ad request and a determined likelihood of the user interacting with content in the ad request. Based on the ranking from the auction process, the ad selector 470 selects one or more ad requests and communicates content of selected ad requests to a client device 110 or to a third party system 130 for presentation to the user.

The campaign data store 475 stores information associated with advertisements in an ad campaign. Advertisements in an ad campaign may be linked by a number of characteristics such as budget, timeframe, or performance objectives. These campaign characteristics can be stored in the campaign data store 475 in association with the specific ad campaign they describe. Additionally, information related to impressions and conversions of advertisements within the ad campaign, ad tracking parameters, and ad group dimensions can also be stored in the campaign data store 475. In some embodiments, tracking tags are also stored in association with ad campaigns in the campaign data store.

The advertising system 150 tracks impressions and conversions of advertisements through the uses of tags, which are created by the tag generator 480. Tags can be appended to a network address or URL to redirect a user through the advertising system 150 before taking them to the original network address or URL. Impressions can be tracked with click tags included in the advertisement. In some embodiments, the click tag or certain information associated with the click tag is appended to the network address that leads to the advertisement's landing page. Conversions can be tracked with action tags that are similarly appended to the network addresses associated with actions on the landing page. Such actions that might typically be tracked as a conversion can include purchasing a product that was advertised, visiting a particular advertised page, interacting with content on a page, joining an advertised group, purchasing tickets to an advertised event, or buying an advertised service, among many other possibilities.

A landing page for an advertisement is the page to which an advertisement leads when a user clicks on a link in the advertisement. A landing page may have multiple actions that can be taken and thus have multiple action tags. For example, an advertisement for a women's clothing store may feature a purple blouse and can have a landing page that is the product page of that purple blouse on the clothing store's website. From there, there are several ways in which the user can interact with the landing page. The user may choose to add the purple blouse to her shopping cart and subsequently purchase the purple blouse. Alternatively, the user might like one of the “recommended” items better, and thus click on a picture of that item, which leads the user to its product page. Alternatively yet, the user may not like the purple blouse or any of the recommended items and instead might browse categories of clothing, like “New Arrivals,” “Top Looks,” or “Petites,” and click on a corresponding link for those categories. Each of those are different actions that can be taken from the advertisement's landing page that the third party system 130 may want to track. Accordingly, each of those actions could have its own associated action tag.

The integration module 485 combines and analyzes the data stored in the campaign data store 475, the ad store 465, the action log 220 and the identity store 205. For example, the integration module 485 can associate an impression that is stored in the action log 220 with a user identity stored in the identity store 205 and advertisement content from an ad campaign stored in the campaign data store 475. The combination of this information then allows the advertising system 150 to be able to identify a user that has interacted with a particular advertisement from a particular ad campaign and some of the circumstances during which that happened (i.e., time of day, day of the week, placement on the viewing page). The integration module 485 can also integrate data between different ad campaigns and different types of ad campaigns by combining data from the different campaigns. For example, the integration module 485 can combine ad impressions and conversions from a search ad campaign and a display ad campaign such that the two campaigns use the same set of user identities. This allows the advertising system 150 to know which search ads and display ads a user has interacted with, despite them being part of different types of ad campaigns. Additionally, in some embodiments, the integration module 485 generates a report based on the data stored in the campaign data store. Using this information, the advertiser can gain various insights into his ad campaigns and how they are each performing (e.g., which of the search ad channel or display ad channel is more effective at getting conversions), can apply attribution models across the channels to attribute credit for the conversion to different impressions across different campaigns, can track campaigns across different devices since the identity of the user is known, and so forth.

The recommendation module 490 uses the integrated impression and conversion data from one or more ad campaigns to recommend one or more publishers 160 to publish an advertiser's ads. Although an advertiser may bid to display ads to a specified user via any of a variety of publishers, the ad may not be displayed to the user if the user does not access content of the publishers on which the advertiser placed bids. Accordingly, to enable the advertiser to focus bidding on ad spaces a user specified by the advertiser is likely to see, the recommendation module 490 identifies one or more publishers 160 whose content the specified user is likely to access (such as publisher web domains the user is likely to visit, or publisher applications the user is likely to use). The recommendation module 490 recommends the advertiser bid on ad space provided by the identified publishers for displaying ads to the user.

The web server 495 links the advertising system 150 via the network 120 to the one or more client devices 110, as well as to the one or more third party systems 130, the online system 140, and the publishers 160. The web server 495 serves web pages, as well as other web-related content, such as JAVA®, FLASH®, XML and so forth. The web server 495 may receive and route messages between the advertising system 150 and the client device 110, for example. A client device 110 may send a communication to the web server 470 to store a cookie in the activity log 455. Additionally, the web server 495 may provide application programming interface (API) functionality to send data directly to native client device operating systems, such as IOS®, ANDROID™, WEBOS® or RIM®.

FIG. 5 is an interaction diagram illustrating a process for logging impressions and conversions of an advertisement by an advertising system 150, according to one embodiment. As shown in FIG. 5, one embodiment of the process comprises interactions between a client device 110, a publisher 160, the advertising 150, and a third party system 130.

Referring to FIG. 5, a third party system 130 may provide 502 an ad to a publisher 160. Using the client device 110, a user accesses 504 a webpage of the publishers 160, which provides 506 the content of the webpage and the ad. The client device 110 displays 506 the ad to the user. In another embodiment, the publisher 160 provides the webpage content and redirects the client device 110 to access the ad from the third party system 130 to display while displaying the webpage. When a user of the client device 110 interacts with the advertisement (such as clicking on the advertisement), the client device 110 receives 510 the user input at the ad and is redirected 512 by the click tag in the advertisement to the advertising system 150. The advertising system 150 logs 514 the impression, including an identifier of the ad that was viewed and the publisher 160 by which the ad was viewed, and directs 516 the client device 110 to the landing page for the advertisement. The third party system 130 sends 518 the landing page to the client device 110 for display 520. If the user takes an action on the landing page (such as adding a product on the landing page to a shopping cart), the client device 110 receives 522 the action and, based on the action tag associated with the action, redirects 524 to the advertising system 150 to log 526 a conversion. The advertising system 150 directs 528 the client device 110 to the action landing page, which the third party system 130 sends 530 to the client device 110 for display 532.

Using the process shown in FIG. 5, the advertising system 150 tracks advertising impressions and conversions.

### Recommending Publishers for Advertising Content

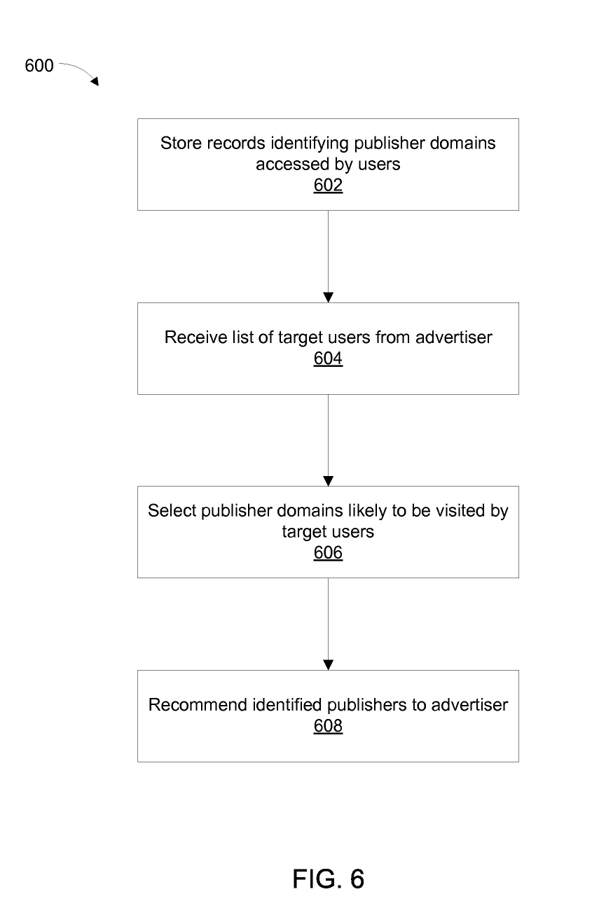

FIG. 6 is a flowchart illustrating a process 600 for recommending one or more publishers 160 to an advertiser for displaying ad content to users. In one embodiment, the process 600 is performed by the advertising system 150. Other embodiments may include additional, fewer, or different steps, and the steps may be performed by different entities.

Referring to FIG. 6, the advertising system 150 stores 602 records identifying web publishers 160 accessed by users of the advertising system 150. In one embodiment, the advertising system 150 determines the web publishers 160 accessed by the users by identifying publishers 160 by which the users viewed advertisements. As users browse web content offered by publishers 160, the publishers display ads to the users along with the web content. When a user clicks on or selects an ad, as described with respect to FIG. 5, a click tag in the ad redirects the user's browser to the advertising system 150. Based on the redirect, the advertising system 150 identifies the ad, the user who clicked on the ad, and the publisher 160 by which the user viewed the ad. As users interact with publishers' content and advertisements displayed by the publishers 160, the advertising system 150 progressively generates and stores records of the publishers 160 by which the users viewed advertisers' ads. Thus, a record stored by the advertising system 150 identifies a particular ad impression, including the ad that was displayed, the publisher that displayed the ad, the user who viewed the ad, and the time the user viewed the ad. The advertising system 150 may store additional information with each impression record, such as the ad campaign that includes the viewed ads, the advertisers who provided the viewed ads, or other information. The advertising system 150 may additionally or alternatively receive a list of users who have accessed content of a particular publisher from the publisher 160.

The advertiser selects a set of target users to whom the advertiser intends to deliver an advertisement. The advertiser may select users based on demographics of the target users, actions performed by the target users, websites visited by the target users, or any of a variety of other factors. For example, the advertiser selects a set of users who are a particular age and who have expressed interest in purchasing a particular product (by, for example, adding the product to a shopping cart on an ecommerce website) as target users for receiving a particular advertisement or set of advertisements. The advertiser retrieves unique identifiers of each of the target users, which may be personally identifiable information such as email addresses or phone numbers of the users provided by users when, for example, the users created an account with a website of the advertiser or purchased products or services from the advertiser. The advertiser sends the list of identifiers of the target users to the advertising system 150.

The advertising system 150 receives 604 the list of target users from the advertiser. In one embodiment, the advertising system 150 identifies users based on identifiers of the users at the online system 140, rather than the personally identifiable information used by the advertisers to identify users. To identify the users in the list received from the advertiser, the advertising system 150 may hash the received user identifiers and send the hashed identifiers to the online system 140, which converts the advertiser identifiers to online system identifiers of the users, hashes the online system identifiers, and returns the hashed online system identifiers to the advertising system 150. Using the hashed online system identifiers of the users, the advertising system 150 retrieves the records of publishers 160 previously accessed by the target users. The advertising system 150 may retrieve the records associated with one or more ad campaigns of the advertiser, or may retrieve records associated with ad campaigns of several advertisers.

Based on the records of publishers 160 previously accessed by the target users, the advertising system 150 selects 606 one or more publishers likely to be accessed by the target users as publishers to recommend to the advertiser. From the publisher records, the advertising system 150 identifies any publishers by which the target users viewed ad content during one or more previous ad campaigns of the advertiser and/or other advertisers. The advertising system 150 ranks the publishers according to a number of times users accessed content of each publisher during one or more selected ad campaigns. In one embodiment, the advertising system 150 ranks the publishers based on a total number of times the target users accessed content provided by the publishers during one or more ad campaigns of the advertiser. The advertising system 150 selects one or more publishers accessed a greatest number of times by the target users (e.g., the five highest-ranked publishers), or selects one or more publishers accessed at least a threshold number of times. In another embodiment, the advertising system 150 ranks the publishers based on a median number of times each user accessed content of a respective publisher during the ad campaigns, and selects one or more publishers having a greatest median number of accesses or having at least a threshold median. In yet another embodiment, the advertising system 150 determines a percentage of the ad impressions in one or more ad campaigns that were provided by each publisher and ranks the publishers based on the percentages. The advertising system 150 then selects one or more publishers providing a greatest percentage of the ad impressions, or publishers providing at least a threshold percentage of the ad impressions.

The advertising system 150 may select the ad campaigns to use for ranking the publishers based on a variety of factors, such as dates of the ad campaigns (e.g., select ad campaigns that occurred in the last year), targeting criteria of the ad campaigns (e.g., select campaigns having targeting criteria at least partially met by the target users), or a number of ad impressions associated with the ad campaigns (e.g., select campaigns during which at least a threshold number of ad impressions were made). Furthermore, the advertising system 150 may identify publishers by which users similar to the target users viewed ad content. For example, the online system 140 sends the advertising system 150 identifiers of users similar to the target users, such as users with similar demographic characteristics to the target users, users having similar interests as the target users, or users having a high affinity to the target users.

The advertising system 150 recommends 608 the selected publishers 160 to the advertiser as domains for publishing the ads targeted to the users in the list. The advertising system 150 may provide information about the distribution of the users' web traffic associated with the recommended publishers 160. For example, the advertising system 150 provides a percentage of ad impressions in the one or more analyzed ad campaigns that were provided by a particular publisher. Alternatively, the advertising system 150 provides the advertiser with the numbers of times content associated with each recommended publisher 160 was accessed by the target users. In one embodiment, the advertising system 150 recommends the publisher allocate a specified percentage of advertising bids to a selected publisher. The advertising system 150 may recommend the advertiser allocate a percentage of bids to a given publisher that is proportional to the percentage of ad impressions in an ad campaign provided by the publisher. For example, the advertising system 150 recommends the advertiser bid on ad space on publishers A, B, and C, where 20% of the ad impressions associated with one of the advertiser's ad campaigns were from publisher A and publishers B and C each provided 10% of the ad impressions in the campaign. Based on the proportions between the percentage of ad impressions associated with each recommended publisher, the advertising system 150 recommends the advertiser allocate 50% of its bids for advertising to the target users to publisher A and allocate 25% of the bids to each of publishers B and C.

By recommending publishers to the advertiser, the advertising system 150 enables the advertiser to bid on ad space that is likely to be accessed by the target users. Thus, embodiments described herein improve the likelihood of users targeted by an advertiser seeing the advertiser's ads.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
storing, at an advertising system, records of web publishers accessed by each of a plurality of users of the advertising system, the records indicating for each of the web publishers which of the users have accessed sites of the web publisher;
receiving identifiers of a set of users targeted by an advertiser for receiving one or more advertisements from the advertiser;
selecting, using the stored records, one or more web publishers to recommend to the advertiser for publishing the one or more advertisements targeted to the set of users, the one or more web publishers selected using a likelihood of the target users accessing content provided by the selected web publishers based on the target users having previously accessed sites of the web publishers; and
recommending the one or more selected web publishers to the advertiser for presenting ads to the target users.

2. The method of claim 1, further comprising:
determining a web publisher by which a user of the advertising system viewed an advertisement provided by the advertiser; and
generating a record identifying the determined web publisher and the user of the advertising system.

3. The method of claim 2, wherein determining the web publisher by which the user viewed the advertisements comprises:
receiving a redirect from a client device used by the user, the redirect generated by a click tag associated with the advertisement in response to the user selecting a link in the advertisement displayed at the client device, wherein the redirect includes an identifier of the user, an identifier of the advertisement, and an identifier of the web publisher; and
generating the record responsive to receiving the redirect.

4. The method of claim 2, wherein the record further identifies an ad campaign with which the advertisement viewed by the user is associated, and wherein selecting the one or more publishers to recommend to the advertiser comprises:
determining based on the stored records, a number of times the target users viewed one or more advertisements associated with a specified ad campaign by each of a plurality of web publishers; and
selecting the one or more web publishers based on the determined number of times each web publisher was used to view the one or more advertisements.

5. The method of claim 1, wherein selecting the one or more web publishers to recommend to the advertiser comprises:
identifying based on the stored records, a plurality of web publishers accessed by each of the target users and a number of times each web publisher was accessed; and
selecting one or more of the web publishers accessed a greatest number of times.

6. The method of claim 1, wherein selecting the one or more web publishers to recommend to the advertiser comprises:
identifying based on the stored records, a plurality of publishers accessed by each of the target users and a number of times each web publisher was accessed; and
selecting one or more of the web publishers accessed at least a threshold number of times.

7. The method of claim 1, wherein selecting the one or more web publishers to recommend to the advertiser comprises:
identifying one or more web publishers accessed by users similar to the target users.

8. The method of claim 1, wherein recommending the selected web publishers to the advertiser comprises:
recommending the advertiser allocate a specified percentage of advertising bids to each selected publisher.

9. The method of claim 8, further comprising:
determining based on the stored records, a number of times the target users accessed each web publisher;
calculating a percentage of the access times allocated to each web publisher; and
determining the specified percentage of advertising bids to recommend to the advertiser based on the calculated percentages.

10. The method of claim 1, wherein receiving the identifiers of the target users comprises:
receiving personally identifiable information of each of the target users;
requesting hashed profile identifiers of the target users from a social networking system, the social networking system retrieving identifiers of profiles of the target users using the personally identifiable information and hashing the retrieved profile identifiers to generate the hashed profile identifiers; and
retrieving advertising system identifiers of the target users using the hashed profile identifiers.

11. A non-transitory computer readable storing medium storing computer program instructions, the instructions when executed by a processor causing the processor to:
store at an advertising system, records of web publishers accessed by each of a plurality of users of the advertising system, the records indicating for each of the web publishers which of the users have accessed sites of the web publisher;
receive identifiers of a set of users targeted by an advertiser for receiving one or more advertisements from the advertiser;
select, using the stored records, one or more web publishers to recommend to the advertiser for publishing the one or more advertisements targeted to the set of users, the one or more web publishers selected using a likelihood of the target users accessing content provided by the selected web publishers based on the target users having previously accessed sites of the web publishers; and
recommend the one or more selected web publishers to the advertiser for presenting ads to the target users.

12. The non-transitory computer readable storage medium of claim 11, further comprising instructions that cause the processor to:
determine a web publisher by which a user of the advertising system viewed an advertisement provided by the advertiser; and
generate a record identifying the determined web publisher and the user of the advertising system.

13. The non-transitory computer readable storage medium of claim 12, wherein the instructions causing the processor to determine the web publisher by which the user viewed the advertisements comprise instructions that cause the processor to:
receive a redirect from a client device used by the user, the redirect generated by a click tag associated with the advertisement in response to the user selecting a link in the advertisement displayed at the client device, wherein the redirect includes an identifier of the user, an identifier of the advertisement, and an identifier of the web publisher; and
generate the record responsive to receiving the redirect.

14. The non-transitory computer readable storage medium of claim 12, wherein the record further identifies an ad campaign with which the advertisement viewed by the user is associated, and wherein the instructions that cause the processor to select the one or more publishers to recommend to the advertiser comprise instructions causing the processor to:
determine based on the stored records, a number of times the target users viewed one or more advertisements associated with a specified ad campaign by each of a plurality of web publishers; and
select the one or more web publishers based on the determined number of times each web publisher was used to view the one or more advertisements.

15. The non-transitory computer readable storage medium of claim 11, wherein the instructions causing the processor to select the one or more web publishers to recommend to the advertiser comprise instructions that cause the processor to:
identify based on the stored records, a plurality of web publishers accessed by each of the target users and a number of times each web publisher was accessed; and
select one or more of the web publishers accessed a greatest number of times.

16. The non-transitory computer readable storage medium of claim 11, wherein the instructions causing the processor to select the one or more web publishers to recommend to the advertiser comprise instructions that cause the processor to:
identify based on the stored records, a plurality of publishers accessed by each of the target users and a number of times each web publisher was accessed; and
select one or more of the web publishers accessed at least a threshold number of times.

17. The non-transitory computer readable storage medium of claim 11, wherein the instructions causing the processor to select the one or more web publishers to recommend to the advertiser comprise instructions that cause the processor to:
identify one or more web publishers accessed by users similar to the target users.

18. The non-transitory computer readable storage medium of claim 11, wherein the instructions causing the processor to recommend the selected web publishers to the advertiser comprise instructions that cause the processor to:
recommend the advertiser allocate a specified percentage of advertising bids to each selected publisher.

19. The non-transitory computer readable storage medium of claim 18, further comprising instructions that cause the processor to:
determine based on the stored records, a number of times the target users accessed each web publisher;
calculate a percentage of the access times allocated to each web publisher; and
determine the specified percentage of advertising bids to recommend to the advertiser based on the calculated percentages.

20. The non-transitory computer readable storage medium of claim 11, wherein the instructions causing the processor to receive the identifiers of the target users comprise instructions that cause the processor to:
receive personally identifiable information of each of the target users;
request hashed profile identifiers of the target users from a social networking system, the social networking system retrieving identifiers of profiles of the target users using the personally identifiable information and hashing the retrieved profile identifiers to generate the hashed profile identifiers; and
retrieve advertising system identifiers of the target users using the hashed profile identifiers.
